(19) United States
(12) Patent Application Publication
(10) Pub. No.: US 2025/0124504 A1
(43) Pub. Date: Apr. 17, 2025

(54) METHOD AND SYSTEM FOR PREDICTING AND FUNDING CASH FLOW GAPS IN A CONSUMER'S BANKING ACCOUNT

(71) Applicant: Mastercard International Incorporated, Purchase, NY (US)

(72) Inventors: William Kerwick, New York, NY (US); Aditi Badrinarayan, New York, NY (US); Ian Goldberg, Township of Washington, NJ (US); Sarah Sherman, Maplewood, NJ (US)

(73) Assignee: Mastercard International Incorporated, Purchase, NY (US)

(21) Appl. No.: 18/488,996

(22) Filed: Oct. 17, 2023

(51) Int. Cl. G06Q 40/03; G06Q 20/02; G06Q 20/10

(52) U.S. Cl. CPC G06Q 40/03; G06Q 20/023; G06Q 20/108

(57) ABSTRACT

The present invention provides a method for predicting future cash flow gaps in a Consumer's banking account. The method reads and analyzes the open banking data in a banking account to predict cash flow gaps. Past and contemporaneous credits, debits, and other transactions are analyzed to predict future cash flow gaps. If future cash flow gaps are predicted, an alert is provided along with options to cure the predicted cash flow gap. Once an option to cure the predicted cash flow gap is selected, a payment service provider transfers funds to the consumer's banking account to cover the cash flow gap. The funds are provided by an earned wage access provider that handles risk and repayment. After a predetermined date, once the consumer has sufficient funds in their banking account, the payment service provider initiates an ACH debit instruction to repay the funds back to the earned wage access provider.

### TECHNICAL FIELD

The present invention relates to method of opening banking and earned wage access (EWA) services to both predict cash flow gaps in a consumer's banking account and to provide short-term funding options to cover the cash flow gaps.

### BACKGROUND

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present invention.

Recent advances in financial technology have enabled more liquidity in earnings and wages. Immediate access to earned cash has grown increasingly important for both small and medium-sized businesses (SMBs) and consumers. In a recent survey, 60% of small businesses said it was important for them to have access to cash as quickly as possible. Earned wage access (EWA) is a financial service that provides employees access to a portion of their earned wages before the end of their payroll cycle. This service can be enabled using an open banking access to the consumer's (an employee or a business) banking account. Open banking systems allow third-party access to a consumer or business banking account through the use of application programming interfaces (APIs). Through open banking, the third-party financial services companies, with the consumer's permission, can access the consumer's personal financial data. This system is typically enabled through APIs. An API is a software component that allows two different applications to communicate with each other. Therefore, EWA services and open banking services can access a consumer's banking accounts to allow payment transfers and debits to and from the consumer's banking accounts.

In research by PYMNTS.com, findings show that 70% of U.S. millennials live paycheck to paycheck, as do 66% of U.S. adults generally. These findings are not limited to lower-income householders; 53% of adults that earn between $50,000 and $100,000 a year also live paycheck to paycheck. The demand for instant payments and quick access to cash is driven by these groups and is further validated by large payment processors who have enabled real-time payments (RTP) and send capabilities. These groups are the backbone of our economy and are constantly looking for ways to get faster access to their money. For example, 60% of SMBs surveyed said that receiving payments as fast as possible is critical for their business. When consumers experience cash flow gaps and cash constraints, they are faced with late fees on bills, missed payroll for employees, overdraft fees from the bank, loss of confidence in their payment source, reputational and credit record injury, and other sources of immense stress and friction for the consumers.

What is needed is a trusted system and method for both predicting cash flow gaps in the consumer's banking account and systems for providing funding options to the consumer. It is an aim of the present disclosure to address these issues.

### SUMMARY

In view of the above needs, a system and method for reading and analyzing a consumer's open banking data in the consumer's banking account to predict gaps in the consumer's cash flow while offering funding options is needed. The term “consumer” can refer to individuals or businesses. Concepts of the present invention comprises analyzing the consumer's past and contemporaneous banking transactions (including credits and debits) to determine potential future gaps in the consumer's cash flow. The system and method alert the consumer to a predicted cash flow gap in the near future.

In an embodiment, once the consumer is alerted of the potential cash flow gap; the system works with payment service providers (PSPs) or payment to generate funding options. The consumer is then presented with options to fund the predicted cash flow gap. The consumer has the opportunity to accept the funding options and/or provide parameters for acceptable funding options. Once a funding option is agreed upon, the PSP transfers funds to the consumer's account to cover the predicted cash flow gap upon approval from the consumer and approval from a payment service provider. The payment service provider deposits the funds into the consumer's account. Within a short period of time, about one to two weeks, on a predetermined date and once the consumer has sufficient funds in their banking account, the payment service provider initiates an ACH debit instruction to repay the funds back to the payment service provider.

In an embodiment, an acquirer or PSP accepts the risk, clears the payment, and transfers the funds to the consumer's account. The acquirer and/or PSP uses the open banking data to access the risk of the short-term loan. Based upon the risk, the acquirer may charge fees or interests for the short-term loan.

In a further embodiment, the funds are transferred to the consumer's account using any number of networks known in the art for transferring funds electronically, including the real-time payments network (RTP) or the Mastercard Send network.

In an embodiment, on a predetermined date and when the consumer has enough funds, then the EWA provider initiates an automated clearing house (ACH) debit instruction to repay the funds and the acquirer clears the ACH debit and deposits the funds back into the payment services provider.

In a further embodiment, the consumer authorizes an open banking application's access to the consumer's banking account's transaction history and the ability to read and analyze its bank account.

In still a further embodiment, consumers are notified of the cash flow gap via a short messaging service (SMS) message, email, or native operating system (OS) push notification. Next the consumers can approve or reject aspects of the options to fund their cash flow gaps.

Of course, it will be appreciated that the present disclosure is not particularly limited to these effects, there may be others.

The foregoing paragraphs have been provided by way of general introduction and are not intended to limit the scope of the invention disclosed herein or the claims set forth herein. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates a process flow diagram according to embodiments of the disclosure;

FIG. 2 illustrates a flow diagram related to an open banking analysis alert according to embodiments of the disclosure;

FIG. 3 illustrates a section prompts to alert the consumer of a cash flow gap and options to fund the cash flow gap presented to the consumer according to embodiments of the disclosure;

FIG. 4 illustrates a process flow diagram related to funding transfers according to embodiments of the disclosure;

FIG. 5 illustrates a process flow diagram related to payment and debit transfers according to embodiments of the disclosure;

FIG. 6 illustrates a process flow diagram related to repayment of borrowed funds according to embodiments of the disclosure; and

FIG. 7 illustrates a general computing platform.

The figures are described in greater detail in the description and examples below, are provided for purposes of illustration only, and merely depict typical or example embodiments of the disclosure. The figures are not intended to be exhaustive or to limit the disclosure to the precise form disclosed. It should also be understood that the disclosure may be practiced with modification or alteration, and that the disclosure may be limited only by the claims and the equivalents thereof.

### DETAILED DESCRIPTION

Embodiments of the present disclosure are directed to systems, methods, and devices for a method and computer program for predicting cash flow gaps in a consumer's banking account and to provide short-term funding options to cover those cash flow gaps. The details of some example embodiments of the systems, methods, and devices of the present disclosure are set forth in the description below. Other features, objects, and advantages of the disclosure will be apparent to one of skill in the art upon examination of the present description, figures, examples, and claims. It is intended that all such additional systems, methods, features, and advantages be included within this description, be within the scope of the present disclosure, and be protected by one or more of the accompanying claims.

Embodiments herein provide a method and system for predicting and funding cash flow gaps in a consumer's bank account. A banking application with an open data application program interface (API) executing on a computing device for analyzing past and contemporaneous credits, debits, and transactions in the bank account to predict a cash flow gap. The banking application provides alerts to the consumer regarding the predicted cash flow gap in their bank account. The consumer is provided options to fund the predicted cash flow gap. If selected, the payment service provider transfers funds to the bank account to cover the predicted cash flow gap upon acceptance of an option. The cash flow gap funds are provided by an earned wage access provider. The payment service provider credits and transfers funds back to the earned wage access provider after a predetermined period or a predetermined bank account balance.

Referring now to the drawings, wherein like reference numerals designate identical or corresponding parts throughout the several views.

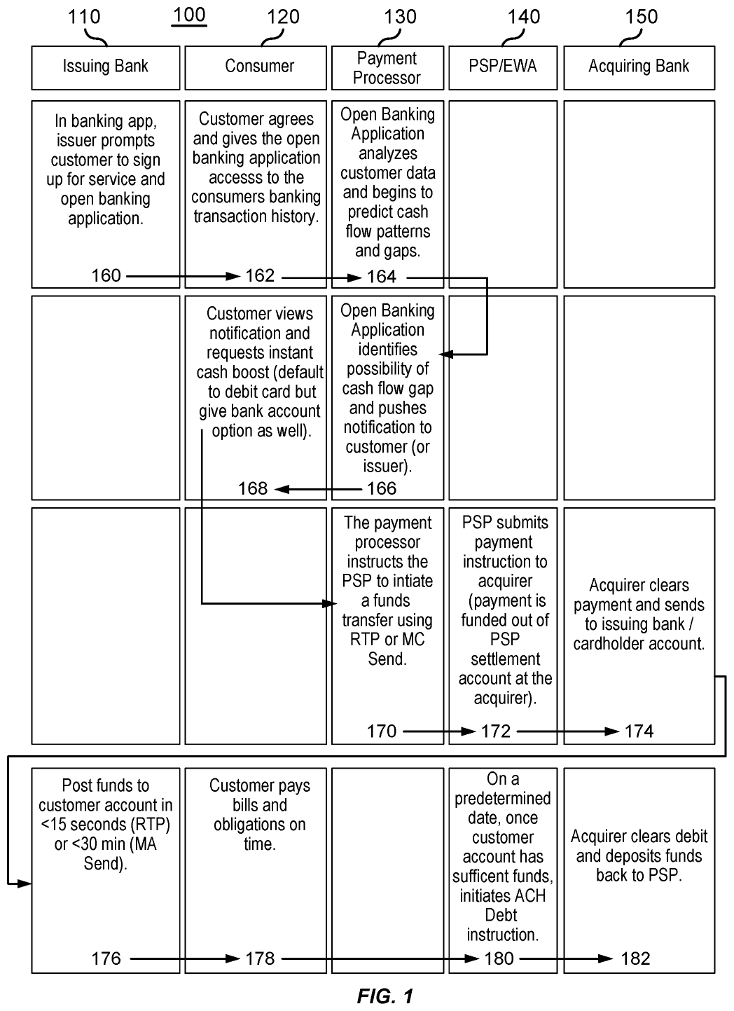

FIG. 1 provides a method 100, according to embodiments of the disclosure, for analyzing and monitoring a Consumer's 120 bank account in order to predict cash flow gaps in the Consumer's 120 bank account and to provide options for funding those predicted cash flow gaps. In the method, an Issuing Bank 110 provides banking account services to Consumers 120. In order to provide its Consumers 120 with a range of account benefits and services, the Issuing Bank 110 prompts the Consumer 120 with an option to allow an open banking application at step 160. Next, if the Consumer 120 agrees to allow the open banking application to access to their bank account at step 162, the open banking application would then have access to the Consumer's 120 entire past and present account history and record at the Issuing Bank 110. This access to past and present account history and records allows the open banking application to analyze the Consumer's 120 bank account to predict future cash flow patterns in step 164. If the open banking application predicts an upcoming cash flow gap, it can alert the Consumer 120 of this predicted cash flow gap at step 166. Typically, this alert can come in the form of a text message or a push notification in the Consumer's 120 mobile banking application in step 166.

Further in FIG. 1, in an embodiment, once the Consumer 120 is alerted of the predicted cash flow gap, the method provides the consumer with an option 168 to fund the predicted cash flow gaps. These options can be in the form of the open banking application sharing information regarding the Consumer's payroll information to an Earned Wage Access (EWA) provider. Analyzing the Consumer's 120 open banking data, the EWA provider can determine if the Consumer's 120 future earnings would be sufficient to cover the Consumer's 120 cash flow gap. At step 168 the Consumer 120 is alerted with at least one option to provide funds to cover the cash flow gap. At step 170, if the Consumer 120 accepts the funding option, a Payment Service Provider 170 is instructed to initiate a funds transfer based upon the Consumer's 120 choice. The funds can be credited to the Consumer's 120 banking or debit card account or transferred to the Consumer's 120 bank account that is associated with the Issuing Bank 110.

Still further in the discussion of FIG. 1, the EWAs are backed by an Acquiring Bank 150. The Acquiring Bank 150 is a financial institution that has relationships with the payment processors and card networks, such as Mastercard, Inc. and Visa, Inc. At step 170, after being prompted by the open banking application within the Consumer's 120 mobile banking application, the Payment Processor 130 submits payment instructions to the Acquiring Bank 150 to initiate a funds transfer via real time payments (RTP) or Master Card Send networks. At step 172, the Acquiring Bank 150 receives these payment instructions from the Payment Service Provider 140 and funds the transfer out of the PSP settlement account at the Acquiring Bank 150. The Acquiring Bank 150 enables cash flow gap funding services (i.e. earned wage access providers) to transfer funds via card transactions on the card networks and accept financial responsibility for that activity. The Acquiring Bank 150 must follow the relevant laws, regulations and card brand rules in providing options to the Consumer 120. The Acquiring Bank 150 perform underwriting and ongoing due diligence to make sure that the funds are repaid. At step 174 the Acquiring Bank 150 clears the payment and transfers the funds to the Consumer's 120 account at the Issuing Bank 120.

Next in FIG. 1, the Acquiring Bank 150 transfers funds to the Consumer's 120 account at the Issuing Bank 110. These funds can be deposited and post to the Consumer's 120 account quickly in as little as 30 seconds at step 176. The Consumer's 120 cash flow gap is funded, and the Consumer 120 is able to pay its obligations at step 178 in a timely manner. The funding option is set to be repaid on a predetermined date or once the Consumer 120 has a sufficient balance from payroll or other fund transfers and the acquirer initiates an automated clearing house (ACH) debit at step 180 to recapture the funds from the Consumer's 120 account at the Issuing Bank 110. At step 182, the funds are transferred from the Consumer's 120 account at the Issuing Bank 110 back to the PSP/EWA's 140 settlement account once the Acquiring Bank 150 clears the ACH debit. The Consumer's 120 repayment obligation is then satisfied with the PSP/EWA 140.

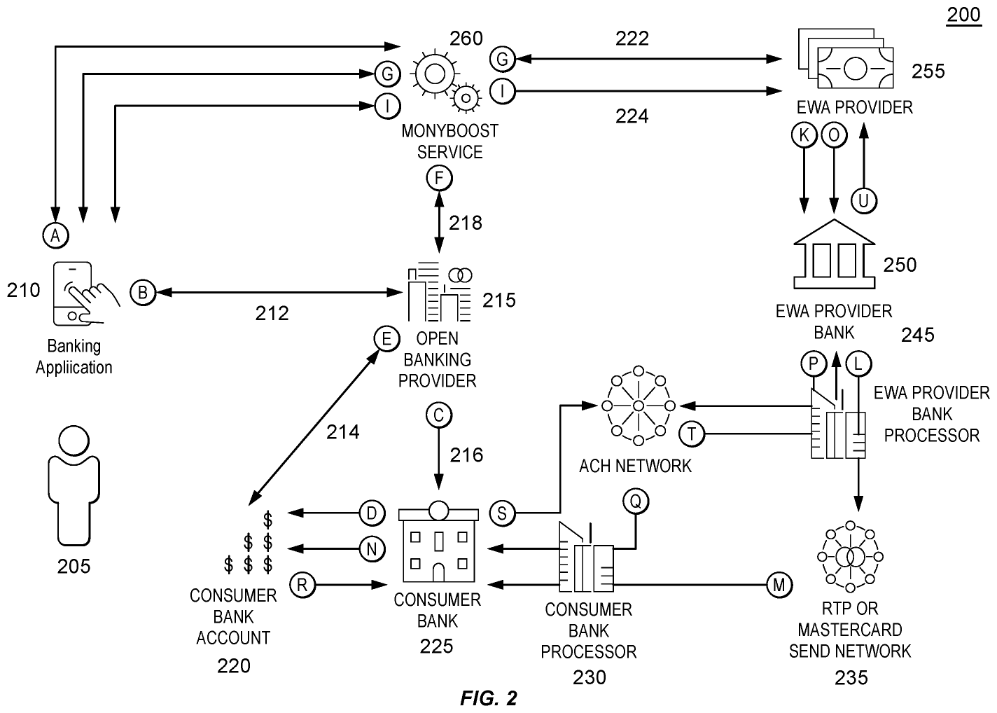

FIG. 2 illustrates a system and apparatus 200 for predicting cash flow gaps in a Consumer's 205 bank account and provides options for funding the predicted cash flow gaps. A Consumer Bank 225 can be a commercial or consumer bank that offers savings and checking accounts as well as other financial services to a Consumer 205. The Consumer 205 can be an individual, a business entity, and/or a non-profit entity. The Consumer 205 maintains an account at their Consumer Bank 225. The Consumer Bank 225 provides a Banking Application 210 that executes on a consumer device such as a smart phone or other computing device. The Consumer 205 uses the Banking Application 210 to monitor and manage their account with the Consumer Bank 225. The Banking Application 210 communicates via a network 212 with an Open Banking Provider 215 and the Consumer Bank 225.

Further in FIG. 2, the Open Banking Provider 215 is a service that is authorized by the Consumer 205 for analyzing and monitoring the Consumer's Bank Account 220 at the Consumer's Bank 225. The Consumer 205 grants the Open Banking Provider 215 access to their Bank Account 220 in order to gain access to a variety of financial services. Access to the Consumer's Bank Account 220 can be granted via a prompt within the Consumer's 205 Banking Application 210. The authorization allows the Open Banking Provider 215 to access the Consumer's Bank Account 220 directly via a network 214. The Open Banking Provider 215 analyzes and monitors the Consumer's 205 past and present financial transactions within the Consumer's Bank Account 220. The Open Banking Provider 215 analyzes, reviews, and collects data related to the Consumer's 205 credits, debits, payments, and other transactions within the Consumer's Bank Account 220.

Further in FIG. 2, a Money Boost Service 260 is provided. The Money Boost Service 260 is an example of the type of financial services that can be provided by the Open Banking Provider 215. In an embodiment, the Money Boost Service 260 is in communication with the Open Banking Provider 215 via a network 218. In a further embodiment the Open Banking Provider 215 can be an application program interface (API) within the Money Boost Service 260. The network 218 allows the Money Boost Service 260 to gather and analyze data related to the Consumer's Bank Account 220 via the Open Banking Provider 215. The Money Boost Service 260 specifically looks for historical and contemporaneous trends and analysis to predict upcoming cash flow gaps related to the Consumer's 205 upcoming debits relative to the Consumer's 205 current account balance and upcoming deposits. The Money Boost Service 260 uses this data to predict future cash flow gaps based the Consumer's 205 current and past banking history. If the Money Boost Service 260 predicts an upcoming cash flow gap, the Consumer 205 is alerted to this potential cash flow gap. These alerts can be provided, for example, via a push notification to the Banking Application 210 and/or a short messaging service (SMS) notification to a user's phone or mobile device; via an email notification; or other secure digital notification services to the consumer 205. The Consumer 205 can then decide whether to fund the cash flow gap on their own or use a funding source offered by the Money Boost Service 260. The Money Boost Service 260 in communication with, for example, an Earned Wage Access (EWA) provider 255 or other financial institution that can present the Consumer 205 with one or more options for funding the predicted cash flow gap. If the Consumer 205 choses to accept an option to fund the cash flow gap, then the Consumer 205 can accept the option, for example, in the Banking Application 210, via text messaging, push notifications, voice systems, email, or other methods.

Further in FIG. 2, the EWA provider 255 allow Consumers 205 early access to parts of their salaries before their scheduled pay period. EWA provider 255 solutions can grant Consumers 205 access to money that they have already earned or base on their predicted future earnings. EWA providers 255 can make predictions regarding the wages that are available to the Consumer 205, for example, based upon their historical open banking data. The EWA provider 255 is backed by, for example, an Acquirer/EWA provider bank 250 or other financial institution that accepts the underwriting and risk of repayment. Once a cash flow gap funding option has been accepted, the system prompts the EWA provider 255 to initiate a funds transfer based upon the respective funding option chosen by the Consumer 205. The EWA provider 255 submits a payment instruction (funds transfer) to the Acquirer/EWA Provider Bank 250. The Acquirer/EWA Provider Bank 250 assumes the risk of repayment and the related underwriting. The funds transfer payment is funded out of a settlement account that EWA Provider Bank Processor 245 has at, for example, the Acquirer/EWA Provider Bank 250 or other financial institution. The Acquirer/EWA Provider Bank 250 authenticates the payment and the EWA Provider Bank Processor 245 initiates a funds transfer via, for example, the RTP, MasterCard Send Network 235, or other banking network transfer system. The RTP or MasterCard Send Network 235 contacts the Consumer Bank Processor 230 to initiate the funds transfer. The Consumer's Bank 225 receives the funds via the Consumer Bank Processor 230. The Consumer's Bank 225 transfers the funds to the Consumer's Bank Account 220. The funds are posted to the Consumer's Bank Account 220, for example, in less than 30 mins using the RTP or MasterCard Send Network 235, or other banking network transfer system. The Consumer 205 is then given access to the funds.

Still in further in FIG. 2, the funds are repaid to the EWA Provider 255 for example, at some agreed upon time, condition, or combination of both. For example, based upon the option the Consumer 205 choose, re-payment may occur on a predetermined date; once the Consumer 205 has a sufficient balance from payroll or other sources; or a combination of both. When conditions have been met for repayment, EWA Provider 255 can contact the Money Boost Service 260 to determine if the funds are available. The Money Boost Service 260 accesses the Open Banking Provider 215 to determine if the Consumer 205 has enough funds in their Consumer Bank Account 220 to repay the EWA Provider 255. If the funds are available and all conditions have been met, EWA Provider 255 alerts the EWA Provider Bank 250 to initiate repayment by requesting that the EWA Provider Bank Processor 245 to send an automated clearing house (ACH) debit instruction. The EWA Provider Bank Processor 245 contacts the ACH network 240 to initiate the funds transfer via the Consumer Bank Processor 230. The Consumer's Bank 225 verifies the funds are available in the Consumer's Bank Account 220 to transfer the funds from the Consumer's Bank Account 220, back, for example, to the EWA Provider Bank Processor 245 settlement account via the ACH Network 240. The EWA Provider Bank 250 then clears the ACH debit and deposits funds back to the EWA Provider 255.

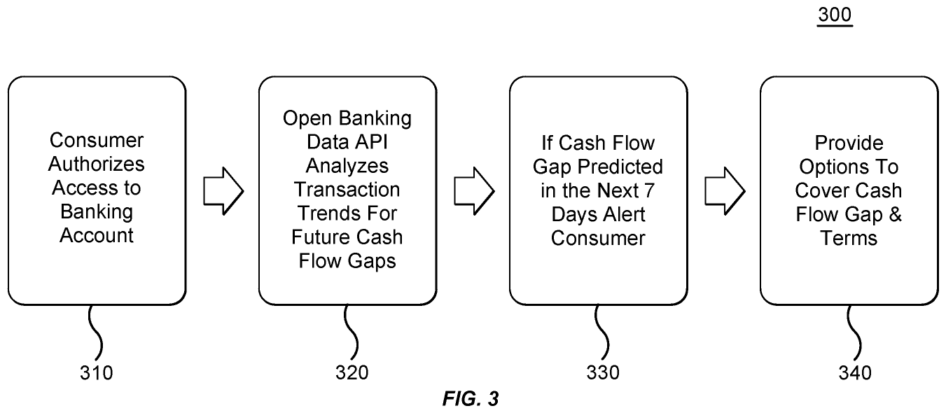

FIG. 3 illustrates a method 300 according to an embodiment of the invention for prompting the Consumer 205 to authorize the process to predict cash flow gaps. According to the method, at step 310, the Consumer 205 authorizes an Open Banking Application 215 access to their Consumer Banking Account 220. At step 320, the Open Banking Application 215 analyzes the current and historical credit, debit, and transaction trends of the Consumer's Bank Account 220 to predict cash flow gaps. Next, at step 330, if a cash flow gap is predicted in the Consumer Banking Account 220 within a set time period, the Consumer 205 is alerted. At step 340, the Consumer 205 is provided with options to cover the cash flow gap along with the terms for repayment.

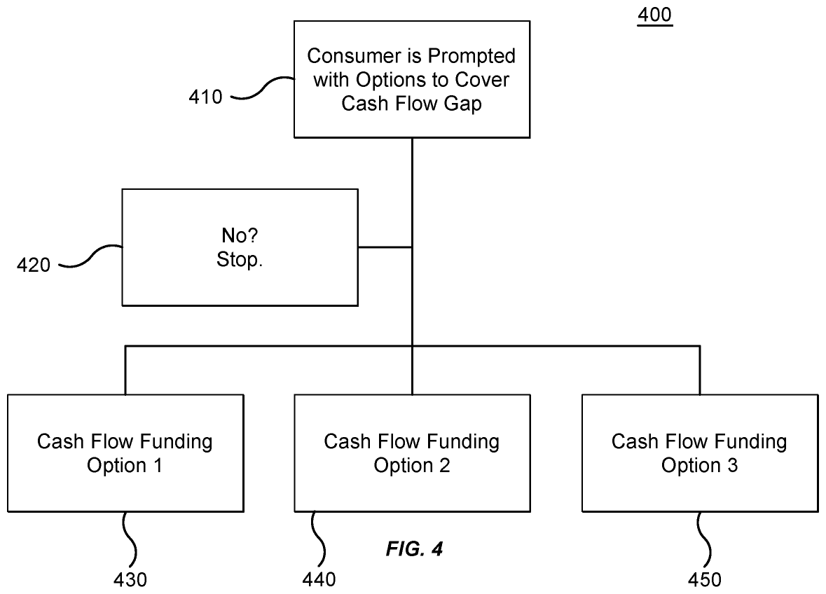

FIG. 4 illustrates a method 400 according to an embodiment of the invention for selecting various cash flow gap options. At step 410, the Consumer 205 is prompted with options to cover a predicted cash flow gap in the Consumer's Bank Account 220. At step 420, the Consumer 205 may elect to do nothing and the prompts end. If the Consumer 205 decides to use the service, the Consumer 205 is presented with one or more funding options in steps 430-450 to cover the cash flow gap. The options may include, for example, more time to repay the funding, varying funding amounts, varying fees, and funding terms, grants, etc. Once the Consumer 205 has selected a funding option 430-450, the funds are transferred to the Consumer's Banking Account 220.

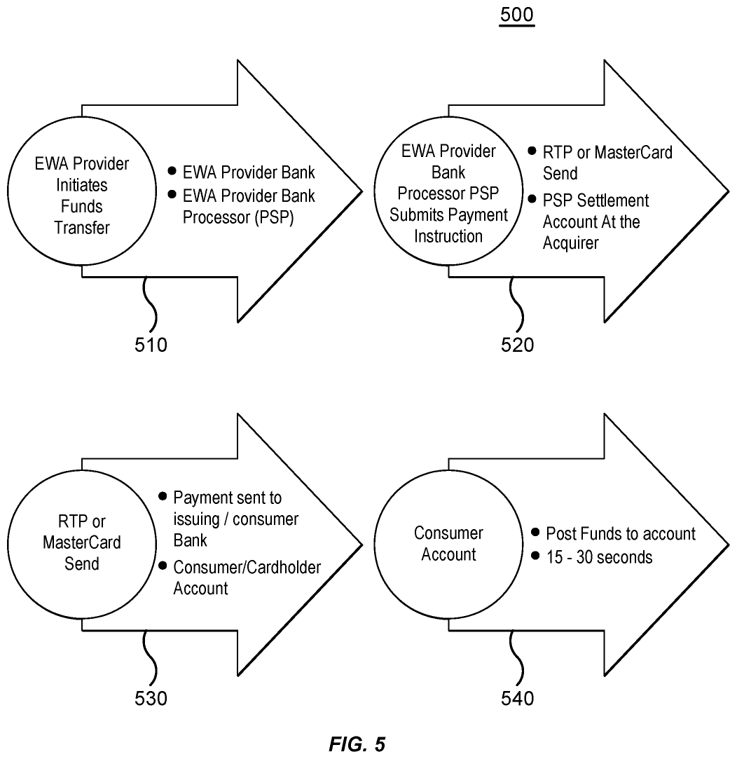

FIG. 5 illustrates a method 500, according to embodiments of the invention, for crediting funds to the Consumer's Bank Account 220 and managing risks. Beginning with step 510, the Consumer 205 has accepted one of the options 430-450 presented in the discussion of FIG. 4 above. This triggers a series of transactions beginning at step 510. At step 510, the Acquirer/EWA Provider 255 initiates a funds transfer to the Consumer's Banking Account 220 in the amount selected based upon the options 430-450 presented in the discussion of FIG. 4. For example, a RTP, Master Card send service, or other banking transfer service request is forwarded by the EWA Provider Bank Processor 245 to RTP/MC Send Network 235 on to the Consumer Bank Processor 230. At step 520, the Acquirer/EWA Provider 255 submits a payment request to the Acquirer/EWA Provider Bank 250. The Acquirer/EWA Provider Bank 250 funds the transactions in addition to handling risk and repayment. The Acquirer/EWA Provider Bank 250 scores the risk of the repayment using the open banking data. This risk scoring may be based on, for example, a number of factors including average account balance; frequency of deposits and credits; frequency and number of overdrafts; revolving credit accounts linked to the Consumer's Bank Account 220; type of financial institution hosting the Consumer's Bank Account 220; age of the account; number of accounts the consumer has with the banking institution, types of transactions triggering the funding gap, etc. The EWA Provider Bank Processor 245 clears the payment so that the payments are sent the Consumer's Bank Account 220 at the Issuing Bank 110. The transfer can occur rather quickly at step 540, wherein the Consumer's Bank Account 220 receives the funds, for example, in as little as thirty (30) seconds and posts the funds to the Consumer's Bank Account 220.

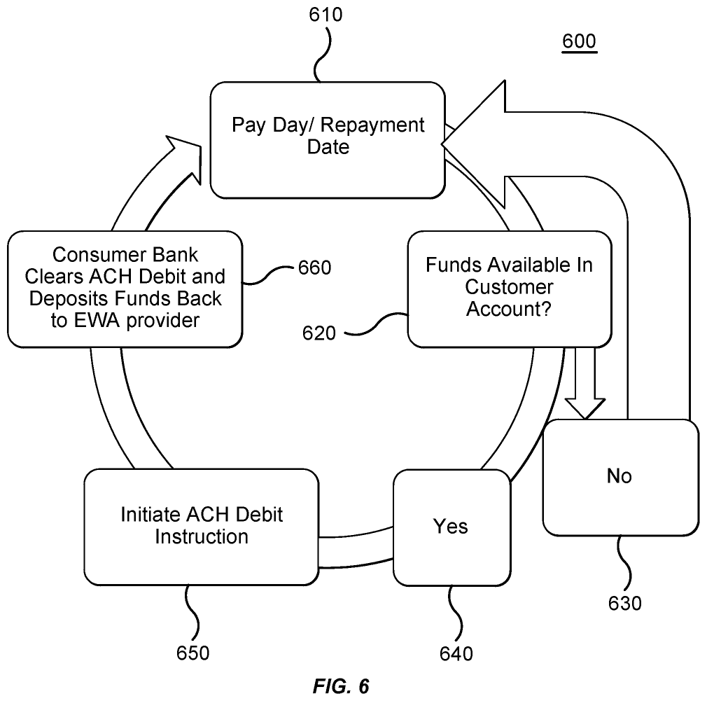

FIG. 6 illustrates a method 600, according to embodiments of the invention, for repaying funds from the Consumer's Bank Account 220 back to the EWA Provider Bank 245 or financial institution. Beginning at step 610, the agreed upon repayment terms, as selected in options 430-450 in the discussion of FIG. 4 above, has occurred. At step 620 the Open Banking Provider 215 verifies if the funds are available in the Consumer's Bank Account 220. If the funds are not available, the Open Banking Provider 215 notes the funds are not available at step 630. The process between steps 610-630 repeat themselves until the funds become available, or until a maximum number of attempts to repay the funds have been reached. Further at step 620, if the funds are available, the Open Banking Provider 215 acknowledges the funds are available at step 640. This prompts the EWA Provider Bank 250 to initiate an ACH debit instruction to the EWA Provider Bank Processor 245 at step 650. At step 660, the Consumer Bank Processor 230 clears the ACH debit and deposits the funds back, for example, to the EWA Provider Bank Processor 245 or financial institution via the ACH Network 240. The Money Boost Service 260 continues to analyze the Consumer's Banking Account 220 for future cash flow gaps.

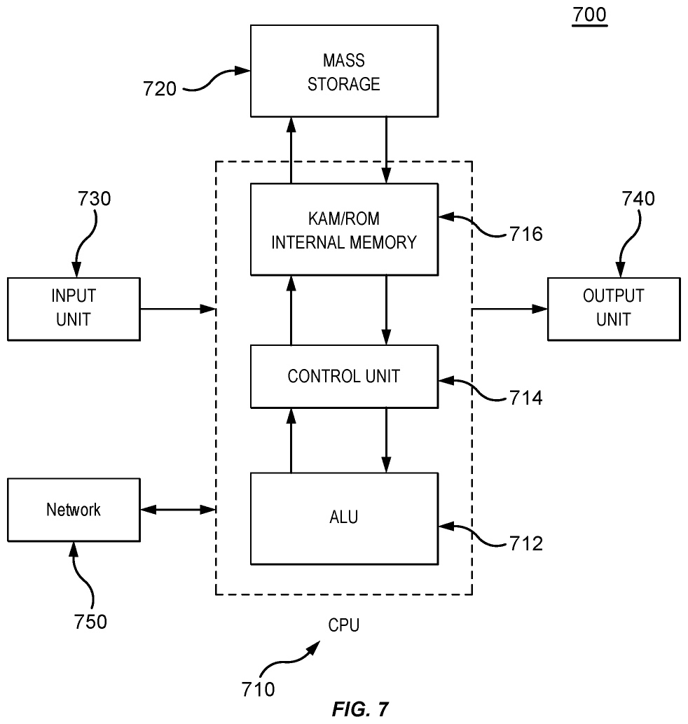

FIG. 7 illustrates a general-purpose computer 700 connected to a network 750. Indeed, in embodiments, the general-purpose computer 700 may also be a server. The general-purpose computer 700 comprises a central processing using 710 in communication with a mass storage device 720. The general-purpose computer 700 receives inputs from an input unit 730. The general-purpose computer 700 produces output via an output unit 740. The general-purpose computer 700 is controlled using a microprocessor or central processing unit 710. The general processing unit 710 is comprised of an arithmetic logic unit 712, a control unit 714, and an internal memory 716. More generally, the general-purpose computer 700 is a data processing apparatus of the disclosure. Typically, the general-purpose computer 700 according to embodiments of the disclosure is a computer device such as a personal computer or a terminal connected to a server. Indeed, in embodiments, the general-purpose computer 700 may also be a server.

Accordingly, in so far as embodiments of the disclosure have been implemented, at least in part, by a software-controlled general-purpose computer 700, it will be appreciated that a non-transitory machine-readable medium or memory 720 carrying such software, such as an optical disk, a magnetic disk, semiconductor memory or the like, is also considered to represent an embodiment of the present disclosure.

It should also be appreciated that one or more aspects of the present disclosure transform a general-purpose computing device into a special-purpose computing device when configured to perform the functions, methods, and/or processes described herein.

Numerous modifications and variations of the present disclosure are possible in light of the above teachings. It is therefore to be understood that within the scope of the appended claims, the disclosure may be practiced otherwise than as specifically described herein.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.
arned wage access provider.

1. A method for predicting and funding cash flow gaps in a bank account, the method comprising:
analyzing past and contemporaneous credits, debits, and transactions in the bank account to predict a cash flow gap;
providing alerts regarding the predicted cash flow gap;
providing options to fund the predicted cash flow gap; wherein upon acceptance of an option:
providing funding from a banking source;
transferring funds to the bank account to cover the predicted cash flow gap;
debiting the bank account in accordance with the option, after a predetermined period, and
transferring funds back to the banking source.

2. The method according to claim 1, wherein the funds are provided from the banking source's settlement account at a payment service provider.

3. The method according to claim 2, wherein the banking source is an earn wage access provider that accepts the risk, clears the payment, and transfers the funds to the bank account.

4. The method according to claim 3, wherein the funds are transferred to the bank account using the real-time payments network (RTP) or the Mastercard Send network.

5. The method according to claim 3, wherein on a predetermined date and when the bank account has enough funds, then the earned wage access provider initiates an automated clearing house (ACH) debit instruction to transfer funds from the bank account to the earned wage access provider's settlement account at the payment service provider for repayment.

6. The method according to claim 3, wherein an open banking application is authorized to access the bank account's debit, credit, and transaction history to gather the bank account's open banking data.

7. The method according to claim 4, wherein the funds can be credited to a debit card account or transferred to the bank account.

8. The method according to claim 6, wherein the payment service provider and earned wage access provider score the risk of the repayment using the open banking data.

9. The method according to claim 1, wherein the alerts and options are provided via a short messaging service (SMS), email, or native operating system (OS) push notification to a computing device.

10. The method according to claim 9, wherein the account holder can approve or reject aspects of the options to fund the cash flow gap.

11. A system for predicting and funding cash flow gaps in a bank account, the system comprising:
a banking application with an open data application program interface (API) executing on a computing device for analyzing past and contemporaneous credits, debits, and transactions in the bank account to predict a cash flow gap;
the banking application providing alerts regarding the predicted cash flow gap;
the banking application providing options to fund the predicted cash flow gap; and
wherein a payment service provider transfers funds to the bank account to cover the predicted cash flow gap upon acceptance of an option; wherein the funds are provided by a funding source.

12. The system according to claim 11, wherein the funding source is an earned wage access provider.

13. The system according to claim 12, wherein the earn wage access provider accepts the risk, clears the payment, and transfers the funds to the bank account.

14. The system according to claim 13, wherein the funds are transferred to the bank account using the real-time payments network (RTP) or the Mastercard Send network.

15. The system according to claim 14, wherein the funds are provided from the earned wage access provider's settlement account at the payment service provider.

16. The system according to claim 13, wherein the payment service provider credits and transfers funds back to the earned wage access provider's settlement account at the payment service provider after a predetermined period or a predetermined bank account balance.

17. The system according to claim 11, wherein the open banking application is pre-authorized to access the bank account's debit, credit, and transaction history.

18. The system according to claim 11, wherein the payment service provider and earned wage access provider score the risk of the repayment using the open banking data.

19. The system according to claim 11, wherein the alerts and options are provided via a short messaging service (SMS), email, or native operating system (OS) push notification to a computing device.

20. The system according to claim 19, wherein the account holder can approve or reject aspects of the options to fund the cash flow gaps.
